(19) United States
(12) Patent Application Publication
(10) Pub. No.: US 2025/0093454 A1
(43) Pub. Date: Mar. 20, 2025

(54) USE FOR PASSIVE RADIOS

(71) Applicant: Nokia Technologies Oy, Espoo (DK)

(72) Inventors: Nuno Manuel KIILERICH PRATAS, Aalborg (DK); Oana-Elena BARBU, Aalborg (DK); Benny VEJLGAARD, Aalborg (DK); jOHANNES HARREBEK, Aalborg (DK); Simon SVENDSEN, Aalborg (DK)

(21) Appl. No.: 18/819,701

(22) Filed: Aug. 29, 2024

(30) Foreign Application Priority Data
Sep. 18, 2023 (FI) 20236032

(51) Int. Cl. G01S 5/02; H04W 12/06; H04W 12/79

(52) U.S. Cl. CPC G01S 5/0252; G01S 5/0284; H04W 12/06; H04W 12/79

(57) ABSTRACT

There is provided in certain embodiments, an apparatus for storing a plurality of activation identifiers, wherein each activation identifier of the plurality of activation identifiers is associated with a respective passive radio of a plurality of passive radios; receiving a first activation signal; transmitting, in reply to the first activation signal, a response signal that indicates at least one of the plurality of activation identifiers; receiving a response from the respective at least one passive radio that has been activated using the respective at least one activation identifier; measuring at least a positional characteristic of the response from the respective at least one passive radio that is dependent upon at least a relative position between the respective at least one passive radio and the apparatus.

### CROSS-REFERENCE TO RELATED APPLICATION

This application claims priority from, and the benefit of, Finnish Application No. 20236032, filed on Sept. 18^{th}, 2023, the contents of which are hereby incorporated by reference in its entirety.

### Technological Field

Examples of the disclosure relate to a passive radios.

### BACKGROUND

Passive radios allow the transfer of information to a reader when activated by an activator. For example, an activator-reader apparatus can transmit an activation signal indicating an activation identifier and a passive radio receives the activation signal and is activated by the activation identifier. The activated passive radio then transmits, in reply to the received activation signal, a response signal for reception by the activator-reader apparatus. The response signal can be used to convey information from the passive radio to the activator-reader apparatus.

It would be desirable to find technical uses for passive radios.

### BRIEF SUMMARY

According to various, but not necessarily all, examples there is provided an apparatus comprising: means for storing a plurality of activation identifiers, wherein each activation identifier of the plurality of activation identifiers is associated with a respective passive radio of a plurality of passive radios; means for receiving a first activation signal; means for transmitting, in reply to the first activation signal, a signal that indicates at least one of the plurality of activation identifiers; means for receiving a response from the respective at least one passive radio that has been activated using the respective at least one activation identifier; means for measuring at least a positional characteristic of the response from the respective at least one passive radio that is dependent upon at least a relative position between the respective at least one passive radio and the apparatus.

In some but not necessarily all examples, the apparatus comprises an energy store for powering the apparatus and means for charging the energy store via energy harvesting from an external energy source, optionally, via energy harvesting from received radio signals within a defined bandwidth.

In some but not necessarily all examples, the apparatus is configured as a passive device that only transmits in response to reception of activation signals, for example, the first activation signal and a second activation signal, and does not transmit except in response to reception of activation signals, for example, the first activation signal and the second activation signal.

In some but not necessarily all examples, the apparatus comprises means for enabling authentication of a signature for some or all of the plurality of passive radios dependent upon positional characteristics.

In some but not necessarily all examples, the apparatus comprises means for authenticating a signature for some or all of the plurality of passive radios dependent upon the plurality of positional characteristics.

In some examples, the signature is a signature for all of the passive radios or the signature is a signature for a sub-set of the passive radios, optionally the sub-set being associated with an object

In some but not necessarily all examples, the apparatus comprises means for receiving a second activation signal and for transmitting in reply to the second activation signal, a signature response signal that indicates a signature for the plurality of passive radios dependent upon the plurality of positional characteristics.

In some but not necessarily all examples, the authentication comprises a comparison based on the signature and a reference signature.

In some but not necessarily all examples, the signature and the reference signature are time-of-arrival signatures, adapted to time-of-flight signatures, before comparison.

In some but not necessarily all examples, the apparatus comprises means for receiving a signal indicating, for each of the plurality of activation identifiers, a configuration for receiving the response from a respective at least one passive radio that has been selectively activated using the respective activation identifier. Optionally, the configuration signal is the first activation signal.

In some but not necessarily all examples, the apparatus is configured to generate a reference signature as a part of a set-up process. The apparatus comprises means for receiving a first set-up activation signal; means for transmitting, in reply to the first set-up activation signal, a first set-up response signal that indicates some or all of the plurality of activation identifiers; means for receiving, for each of the some or all of the plurality of activation identifiers, a set-up response from a respective passive radio that has been selectively activated using the respective activation identifier; means for measuring at least a positional characteristic of each set-up response from a respective passive radio that is dependent upon at least a relative position of the respective passive radio and the apparatus; means for generating a reference signature for the some or all of the plurality of passive radios dependent upon the plurality of positional characteristics, wherein the authentication of the signature uses the reference signature. In some examples, the reference signature is a reference signature for all of the passive radios or the reference signature is a reference signature for a sub-set of the passive radios, optionally the sub-set being associated with an object.

In some but not necessarily all examples, the apparatus comprises: means for storing reference signatures for the plurality of passive radios, wherein each reference signature is dependent upon reference positional characteristics for the plurality of passive radios in different configurations (optionally the plurality of passive radios being associated with an object having different configurations) or wherein each reference signature is dependent upon reference positional characteristics for a sub-set of the plurality of passive radios in different configurations (optionally the sub-set of the plurality of passive radios being associated with an object having different configurations); and means for receiving a configuration signal indicating one of a plurality of configurations, and means for transmitting a reference signature indication signal that indicates a reference signature for the configuration According to various, but not necessarily all, examples there is provided a method comprising: storing a plurality of activation identifiers, wherein each activation identifier of the plurality of activation identifiers is associated with a respective passive radio of a plurality of passive radios; receiving a first activation signal; transmitting, in reply to the first activation signal, a signal that indicates at least one of the plurality of activation identifiers; receiving, for each of the plurality of activation identifiers, a response from the respective passive radio that has been activated using the respective activation identifier; measuring at least a positional characteristic of each response from the respective passive radio that is dependent upon at least a relative position between the respective passive radio and the apparatus.

According to various, but not necessarily all, examples there is provided instructions that when executed by a processor of an apparatus, enable the apparatus to:
store a plurality of activation identifiers, wherein each activation identifier of the plurality of activation identifiers is associated with a respective passive radio of a plurality of passive radios; transmit, in reply to a received first activation signal, a signal that indicates at least one of the plurality of activation identifiers; measure at least a positional characteristic of responses from passive radios, wherein the positional characteristic is dependent upon at least a relative position of the respective passive radios and the apparatus.

According to various, but not necessarily all, examples there is provided an apparatus (e.g. an activator-reader apparatus) comprising: means for transmitting to another apparatus a first activation signal; and means for receiving from the another apparatus, in reply to the first activation signal, a response signal that indicates one or more activation identifiers wherein each activation identifier is associated with a respective passive radio of a plurality of passive radios.

In some but not necessarily all examples, the apparatus comprises means for using at least one of the plurality of activation identifiers to activate the respective passive radio of the plurality of passive radios.

In some but not necessarily all examples, the apparatus comprises means for transmitting a second activation signal to the another apparatus and receiving in reply a response signal providing a result of authentication of a signature for some or all of the plurality of passive radios and/or means for transmitting a third activation signal to the another apparatus and receiving in reply a response signal enabling at the apparatus authentication of a signature for some or all of the plurality of passive radios.

In some but not necessarily all examples, the apparatus comprises: means for sending to the apparatus a second activation signal; means for receiving from the apparatus in reply to the second activation signal, a signature response signal that indicates a signature for some or all of the plurality of passive radios dependent upon relative positions between the respective passive radio, when activated, and the apparatus; and means for authenticating the signature for some or all of the plurality of passive radios.

In some but not necessarily all examples, the apparatus comprises means for determining whether the signature for some or all of the plurality of passive radios matches a reference signature for some or all of the plurality of passive radios.

In some but not necessarily all examples, the apparatus comprises means for receiving responses from some or all of the plurality of passive radios that have been selectively activated; means for adjusting the signature for some or all of the plurality of passive radios based on the received responses from the some or all of the plurality of passive radios that have been selectively activated.

In some but not necessarily all examples, the apparatus comprises means for transmitting a configuration signal indicating one of a plurality of configurations, and means for receiving a reference signature indication signal that indicates a reference signature for the configuration.

According to various, but not necessarily all, examples there is provided a method comprising: transmitting to an apparatus a first activation signal; receiving from the apparatus, in reply to the first activation signal, a signal that indicates a plurality of activation identifiers including an activation identifier for each of a plurality of passive radios; using each of the plurality of activation identifiers to activate the respective passive radio of the plurality of passive radios; sending to the apparatus a second activation signal; receiving from the apparatus in reply to the second activation signal, a signal that indicates a signature for the plurality of passive radios dependent upon relative positions between the respective passive radio, when activated, and the apparatus; authenticating the signature for the plurality of passive radios.

According to various, but not necessarily all, examples there is provided instructions that when executed by a processor enable an apparatus (e.g. an activator-reader apparatus) to: transmit to another apparatus a first activation signal; receive from the other apparatus, in reply to the first activation signal, a signal that indicates a plurality of activation identifiers including an activation identifier for each of a plurality of passive radios and use each of the plurality of activation identifiers to activate the respective passive radio of the plurality of passive radios; send to the apparatus a second activation signal; and receive from the apparatus in reply to the second activation signal, a signal that indicates a signature for the plurality of passive radios dependent upon relative positions between the respective passive radio, when activated, and the apparatus and authenticate the signature for the plurality of passive radios.

According to various, but not necessarily all, examples there is provided a system comprising: the plurality of passive radios; the activator-reader apparatus; and the apparatus for measuring a positional characteristic of each response from the respective passive radios. In some but not necessarily all examples, the system comprises an object carrying the plurality of passive radios, wherein the means for authenticating the signature for the plurality of passive radios authenticates integrity of the object in that an original plurality of passive radios retain an original relative positioning.

In some but not necessarily all examples, the activator-reader apparatus is or comprises a cellular radio network node, for example a base station or user equipment.

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

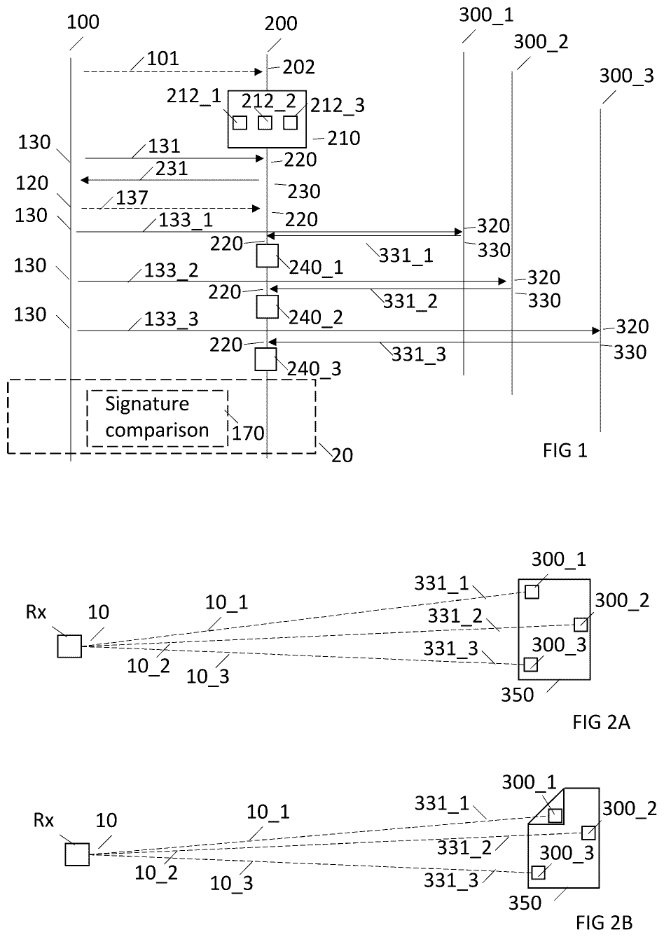

FIG. 1 illustrates an activator-reader apparatus 100, an apparatus 200 and passive radios 300 for example passive radios 300_1, 3002, 300_3;

FIGS. 2A & 2B illustrates the use of the passive radios 300 for determining the physical integrity of an object 350;

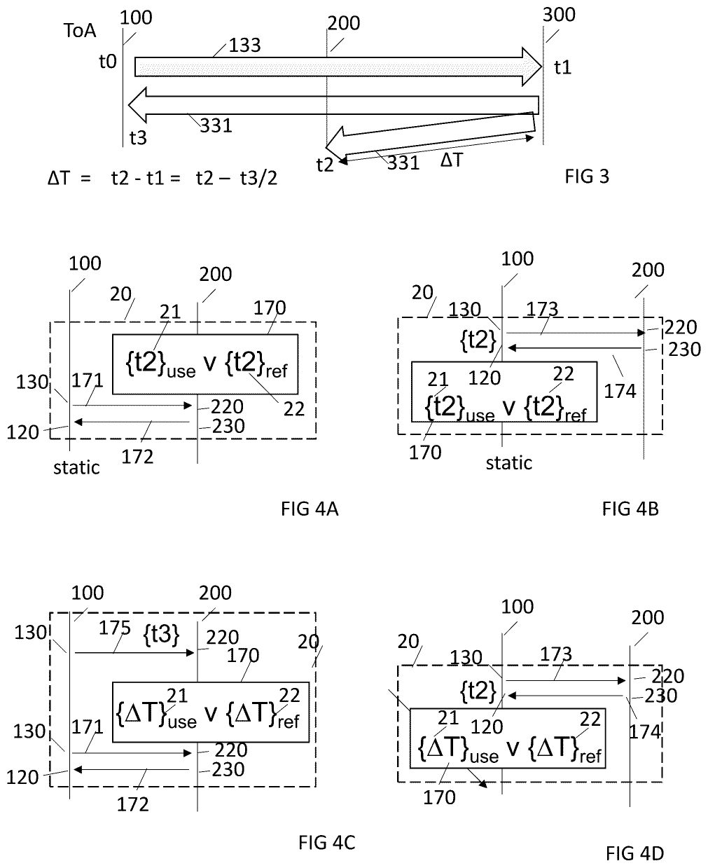

FIG. 3 illustrates the use of time of arrival as a measured positional characteristic for determining a signature 21 representing the physical integrity of an object 350;

FIG. 4A illustrates signature authentication at the apparatus 200;

FIG. 4B illustrates signature authentication at the activator-reader apparatus 200;

FIG. 4C illustrates adapted signature authentication at the apparatus 200;

FIG. 4D illustrates adapted signature authentication at the activator-reader apparatus 200; and

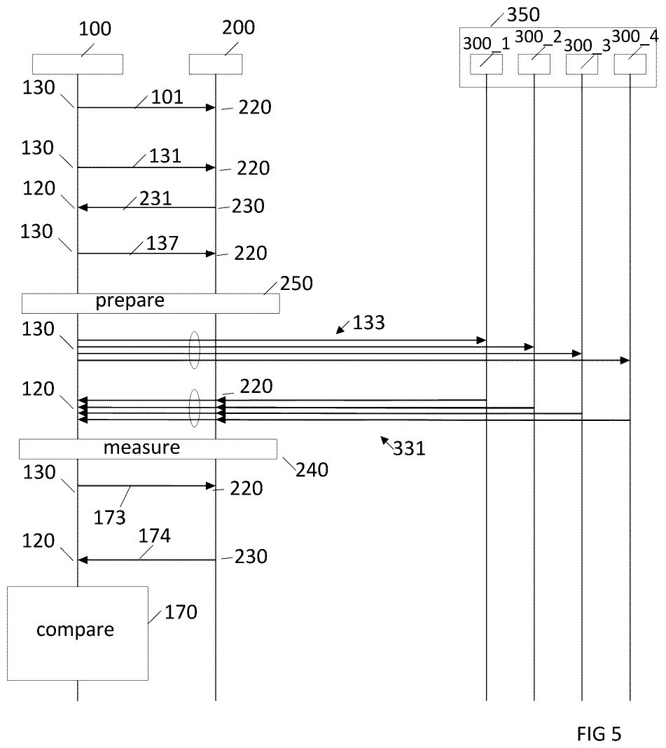

FIGS. 5 to 12 show examples of the subject matter described herein.

The figures are not necessarily to scale. Certain features and views of the figures can be shown schematically or exaggerated in scale in the interest of clarity and conciseness.

For example, the dimensions of some elements in the figures can be exaggerated relative to other elements to aid explication. Similar reference numerals are used in the figures to designate similar features. For clarity, all reference numerals are not necessarily displayed in all figures.

In the following description a class (or set) can be referenced using a reference number without a subscript index (e.g. 10) and a specific instance of the class (member of the set) can be referenced using the reference number with a numerical type subscript index (e.g. 101) and a non-specific instance of the class (member of the set) can be referenced using the reference number with a variable type subscript index (e.g. 10_i).

### Definitions

The term signature is used to represent a data structure that is dependent upon a collection of measured positional characteristics such that a comparison of a first signature dependent upon an ordered collection of measured positional characteristics (first positional characteristics) with a second signature dependent upon an ordered collection of measured positional characteristics (second positional characteristics) is a comparison of the respective first and second positional characteristics.

### DETAILED DESCRIPTION

FIG. 1 illustrates an activator-reader apparatus 100, an apparatus 200 and passive radios 300.

The apparatus 200 stores a plurality of activation identifiers 212 including an activation identifier 212_i for each of a plurality of passive radios 300_i. In some but not necessarily all examples, the activation identifiers 212 are provided to the apparatus 200 by the passive radios 300 during a registration process. Each of the passive radios 300 is associated with a unique identifier (at least in regards to the other passive radios 300 associated with the same object).

The activator-reader 100 transmits and apparatus 200 receives a first activation signal 131 (an identifier activation signal). In reply to the first activation signal 131, apparatus 200 transmits and activator-reader 100 receives, a signal 231 that indicates the plurality of activation identifiers 212 including an activation identifier 212 for each of a plurality of passive radios 300.

The activator-reader 100 uses each of the plurality of activation identifiers 212 to selectively activate 133 the plurality of passive radios 300. The activator-reader 100 transmits a first passive radio activation signal 133_1 dependent on to a first activation identifier 212_1 for a first passive radio 300_1 to the first passive radio 300_1. The activator-reader 100 transmits a second passive radio activation signal 133_2 dependent on a second activation identifier 212_2 for a second passive radio 300_2 to the second passive radio 300_2. The activator-reader 100 transmits a third passive radio activation signal 1333 dependent on a third activation identifier 212_3 for a third passive radio 300_3 to the third passive radio 300_3. Any number of passive radio activation signals 133 can be transmitted to respective passive radios 300.

The passive radio activation signals 133_i, dependent on respective activation identifiers 212_i, cause respective passive radios 300_i to transmit respective responses 331_i. The first passive radio activation signal 133_1 causes a first passive radio 300_1 to transmit a first response 331_1. The second passive radio activation signal 133_2 causes a second passive radio 300_2 to transmit a second response 331_2. The third passive radio activation signal 133_3 causes a third passive radio 300_3 to transmit a third response 331_1.

The apparatus 100 receives, for each of the plurality of activation identifiers 212, a response 331 from a respective passive radio 300 that has been activated using the respective activation identifier 212. The apparatus 200 receives a first response 331_1 from the first passive radio 300_1, a second response 331_2 from the second passive radio 300_2, and a third response 331_3 from the third passive radio 300_3.

The apparatus 100 measures 240 at least a positional characteristic of each response 331 from a respective passive radio 300 that is dependent upon at least a relative position of the respective passive radio 300 and the apparatus 200. The apparatus 100 measures 240_1 a positional characteristic for the received first response 331_1, measures 240_2 a positional characteristic for the received second response 3312, and measures 240_3 a positional characteristic for the received third response 331_3.

In some but not necessarily all examples, after the activator-reader 100 receives the signal 231 that indicates the plurality of activation identifiers 212 in response to the transmitted first activation signal 131 and before it activates the passive radios 300, the activator-reader 100 transmits and the apparatus 200 receives a signal 137 indicating, for each of the plurality of activation identifiers 212, a configuration for receiving responses 331 from a respective passive radio 300 that has been activated 133 using the respective activation identifier 212. A configuration for receiving a response 331 can, for example, indicate resources used for the response such as time resources/instances and frequency resources.

The apparatus 200 comprises:
means 210 for storing a plurality of activation identifiers 212 including an activation identifier for each of a plurality of passive radios 300;
means 220 for receiving a first activation signal 131;
means 230 for transmitting, in reply to the first activation signal 131, a signal 231 that indicates the plurality of activation identifiers 212;
means 220 for receiving, for each of the plurality of activation identifiers 212, a response 331 from a respective passive radio 300 that has been activated using the respective activation identifier 212;
means 240 for measuring at least a positional characteristic of each response 331 from a respective passive radio 300 that is dependent upon at least a relative position of the respective passive radio 300 and the apparatus 200.

The apparatus 200 additionally comprises means 20 for enabling authentication of a signature for the plurality of passive 200 radios dependent upon the plurality of measured positional characteristics.

In some examples, the apparatus 200 is configured to authenticate the signature for the plurality of passive radios dependent upon the plurality of measured positional characteristics.

In some examples the apparatus 200 is configured to enable the activator-reader 100 to authenticate the signature for the plurality of passive radios dependent upon the plurality of measured positional characteristics. In some examples, the apparatus 200 is configured to transmit to the activator-reader 100, in reply to reception of a second activation signal 173 (a signature activation signal), a signal 174 that indicates to the activator-reader 100 the signature for the plurality of passive radios 300 dependent upon the plurality of positional characteristics (See FIGS. 4B, 4D.

In some examples, the authentication comprises a comparison based on the signature and a reference signature. In some examples, the signature and the reference signature are time-of-arrival signatures. In some examples, the signature and the reference signature are time-of-flight signatures, adapted to time-of-flight signatures, before comparison.

The activator-reader apparatus 100 comprises: means 130 for transmitting to an apparatus 200 a first activation signal 131; means 120 for receiving from the apparatus 200, in reply to the first activation signal 131, a signal 231 that indicates a plurality of activation identifiers 212 including an activation identifier 212 for each of a plurality of passive radios 300; means for using each of the plurality of activation identifiers to selectively activate 133 the plurality of passive radios 300.

In at least some examples, the activator-reader apparatus 100 additionally comprises means for sending to the apparatus 200 a second activation signal 173 (a signature request signal); means for receiving from the apparatus 200 in reply to the second activation signal 173, a signature response signal 174 that indicates a signature for the plurality of passive radios 300 dependent upon relative positions of the respective passive radio 300 and the apparatus 200; means for authenticating the signature for the plurality of passive radios 300.

In some but not necessarily all examples, the apparatus 200 comprises an energy store 204 (not illustrated in FIG. 1) for powering the apparatus 100, and comprises energy harvesting means 202 for charging the energy store 204 via energy harvesting from an external energy source 101. In the illustrated example, the external energy source 101 is a received radio signals 101 within a defined bandwidth. In this example, the radio signals 101 are transmitted by the activator-reader 100. The energy store 204 powers the means 210 for storing, the means 230 for transmitting, the means 220 for receiving and the means 240 for measuring.

In some but not necessarily all examples, the apparatus 200 comprises energy harvesting means 202 for providing power being harvested from an external energy source 101 directly to the means 210 for storing, the means 230 for transmitting, the means 220 for receiving and the means 240 for measuring.

In at least some examples the apparatus 200 is a passive device that only transmits in response to reception of an activation signal (It operates under a page-response model). For example, the apparatus 200 transmits a signal 231 that indicates the plurality of activation identifiers 212 in response to first activation signal 131 and the apparatus 200 transmits 235 signal 235 that indicates a signature for the plurality of passive radios dependent upon the plurality of positional characteristics in response to second activation signal 173.

The apparatus 200 can be an ambient internet of things (AIoT) device. An AIoT device is an ambient power-enabled Internet of Things device. It is an IoT device powered by energy harvesting, being either battery-less or with limited energy storage capability (e.g., using a capacitor). For example the apparatus 200 can be an AIoT device of Class A, B or C.

A passive radio 300 is a radio that transmits in response to a received signal. A passive radio can be configured as a passive radio tag. The term ‘tag’ indicates that the passive radio is attached to another object. The passive radio 300 and the passive radio tag have small form factors.

The passive radio tags are attached to an object to monitor the physical integrity of the object. The passive radio tags can also be described as physical integrity tags. They are passive radios attached to an object for the purpose of monitoring the physical integrity of the object.

The activation signals sent from the activator-reader 100 can be encoded with specific identifiers (or have specific sequences that are associated with these identifiers) that lead to activation.

The replies from the passive radios 300 can be mutually orthogonal (especially if these are received at the same time).

The interaction between the activator-reader 100 and the apparatus 200 can be in the form of Medium Access Control (MAC) Control elements (CEs) or radio resource control (RRC) signaling (when the procedure is part of a 3GPP cellular telecommunications network) or application specific messages if left to the upper layers. A core network entity can facilitate this interaction (e.g. using NSA signalling) and an application (outside 3GPP) can control the interaction between activator and reader and application specific messages are used.

The system illustrated in FIG. 1 comprises: the activator-reader apparatus 100, the apparatus 200 and the plurality of passive radios 300. An object can carry the plurality of passive radios 300. The system comprises means for authenticating the signature for the plurality of passive radios 300 to authenticate an integrity of the object in that an original plurality of passive radios retain an original relative positioning. In some examples, the activator-reader system 100 is or comprises a cellular radio network node, for example a base station or user equipment.

FIGS. 2A and 2B illustrate an example of positional characteristics and a change in a signature represented by a group of positional characteristics. The passive radios 300 can be used for determining the physical integrity of an object 350 carrying the passive radios 300 by authenticating the signature.

In FIG. 2A, the plurality of passive radios 300_1, 300_2, 300_2 have a first arrangement. Each passive radio 300_i has a position p1(i) and these positions define a first signature for the plurality of passive radios 300. The first signature for the plurality of passive radios 300 is dependent upon a plurality of measured positional characteristics 10 for the passive radios 300. The measured positional characteristics can for example comprises a time of arrival, a signal strength, and/or and angle of arrival.

In FIG. 2B, the same plurality of passive radios 300_1, 3002, 300_2 have a second arrangement. Each passive radio 300_i has a position p2(i) and these positions define a second signature for the plurality of passive radios 300. The second signature for the plurality of passive radios 300 is dependent upon a plurality of measured positional characteristics 10 for the passive radios 300. The measured positional characteristics can for example comprises a time of arrival, a signal strength, and/or and angle of arrival.

In some examples, the positional characteristic 10 of a response 331 from a respective passive radio 300 is dependent upon a separation distance between the apparatus 200 and the respective passive radio 300. The measured positional characteristics can for example comprises a time of arrival and/or a signal strength.

In the illustrated example, the second arrangement is different to the first arrangement. One or more of the set of positions p2(i) differs from the set of positions p1(i). As a consequence, the second signature is different to the first signature.

In this example, the passive radios 300_1, 300_2, 300_2 are attached to an object 350. FIG. 2A illustrates the object 350 when it has integrity and is undamaged. FIG. 2B illustrates the object 350 when it no longer has integrity and is damaged. In this example, the portion of the object 350 carrying the passive radio 300_1 has been damaged and the passive radio 300_1 have moved relative to the other passive radios 3002, 300_3.

Authenticating the signature (that it has not changed) authenticates integrity of the object in that an original plurality of passive radios retain an original relative positioning.

In the example describe in relation to FIG. 1, the apparatus 200 measures the positional characteristic 10 of a response 331 from a respective passive radio 300 when activated 133.

In some but not necessarily all examples, the activator-reader 100 measures the positional characteristic 10 of a response 331 from a respective passive radio 300 when activated 133.

Authentication of a signature can be by comparison of the current signature against a reference signature. If the current signature is authenticated than the object is undamaged. If the current signature is not authenticated than the object is damaged.

The collection of measured positional characteristic(s) 10 (e.g. the signature) can be used to determine the physical integrity of an object 350.

Referring to FIG. 1, in some example, the apparatus 200 transmits, in reply to the first set-up activation signal 161, a signal 231 that associates the plurality of activation identifiers 212 with an object 350 or that associates exclusive sub-sets of the plurality of activation identifiers 212 with respective objects 350. If the current signature for an object is authenticated then that object is undamaged. If the current signature for an object is not authenticated then that object is damaged.

FIG. 3 illustrates an example where time of arrival (ToA) is used as a measured positional characteristic 10 for determining the physical integrity of an object 350.

In this example, the time is measured from a time reference at the time t0 when the passive radio activation signal 133 is transmitted by the activator-reader apparatus 100. However, this time reference is arbitrary and any time reference can be used. In the following t0 will be assumed to be zero.

The time of arrival (ToA) of the passive radioactivation signal 133 at the passive radio 300 is t1.

The response signal 331, is transmitted by the passive radio 300 in response to receiving the passive radio activation signal 133. The time of arrival (ToA) of the response signal 331 at the apparatus 200 is t2. The time of arrival (ToA) of the response signal 331 at the activator-reader apparatus 100 is t3.

If this is repeated for multiple passive radios 300, there will be sets of ToAs {t1}, {t2}, {t3}. {t2} can be measured by the apparatus 200 (a signature for the apparatus 200) {t3} can be measured by the activator-reader apparatus 100 (a signature for the activator-reader apparatus 100)

A reference signature could be based on {t2} at a reference time e.g. {t2}_{ref}. An in-use signature could be based on {t2} at a later time e.g. {t2}ᵤₛₑ. If there is a consistent positional relationship between activator-reader 100 and passive radios 300 at set-up and use, then the signature {t2}ᵤₛₑ can be compared to the reference signature {t2}_{ref} to authenticate physical integrity. This determination could occur at the apparatus 200 or at the activator-reader apparatus 100 (if the signature and reference signature are transferred from the apparatus 200 to the activator-reader apparatus 100).

FIG. 4A illustrates an example where the signature 21 ({t2}ᵤₛₑ) is compared 170 to the reference signature 22 ({t2}_{ref}), at the apparatus 200, to authenticate 20 physical integrity.

The result of the comparison 170, the authentication determination, is transferred from the apparatus 200 to the activator-reader apparatus 100. The activator-reader apparatus 100 transmits an activation request signal 171 and the apparatus 200 responds with an authentication response signal 172 based on the authentication determination.

FIG. 4B illustrates an example where the signature 21 ({t2}ᵤₛₑ) is compared 170 to the reference signature 22 ({t2}_{ref}), at the activator-reader apparatus 100, to authenticate 20 physical integrity. In order to enable the comparison at the activator-reader apparatus 100, the signature 21 ({t2}ᵤₛₑ) and the reference signature 22 ({t2}_{ref}) are transferred from the apparatus 200 to the activator-reader apparatus 100. The reference signature 22 ({t2}_{ref}) can be transferred in advance of the transfer of the signature 21 ({t2}ᵤₛₑ). The activator-reader apparatus 100 transmits a signature request signal 173 and the apparatus 200 responds with a signature response signal 174 that comprises the reference signature 22 and/or the in-use signature 21 depending on circumstance or the configuration of the request signal 173.

The time of flight of the passive radio activation signal 133 between the activator-reader apparatus 100 and the radio tag 300 is t1. This time of flight is directly proportional to the distance between the activator-reader apparatus 100 and the radio tag 300.

The time of flight of the passive radio activation signal 133 between the radio tag 300 and the apparatus 200 is t2−t1. This time of flight is directly proportional to the distance between the radio tag 300 and the apparatus 200.

The time of flight of the passive radio activation signal 133 between the radio tag 300 and the activator-reader apparatus 100 is t3−t1. This time of flight is directly proportional to the distance between the radio tag 300 and the activator-reader apparatus 100.

The signature {t2} can be adjusted to represent the time of flight between the radio tag 300 and the apparatus 200 (t2−t1). This adjusted signature is a time-of-flight signature {ΔT} where {ΔT}={t2−t1}.

The set {t1} is not measured, however if it is approximately half the time t3 then:

$$\{ Δ T \} = \{ t 2 - t 3 / 2 \}$$

This is independent of the distance between the activator-reader apparatus 100 and the passive radios 300.

A reference signature could be based on the time-of-flight signature {ΔT} at a reference time e.g. {ΔT}_{ref}. An in-use signature could be based on the time-of-flight signature {ΔT}later e.g. {ΔT}ᵤₛₑ.

The signature {ΔT}ᵤₛₑ can be compared to the reference signature {ΔT}_{ref} to ‘authenticate’ physical integrity. The signature {ΔT} is however a function of t2 (the time of arrival of the response signal 331 measured at the apparatus 200) and t3 (the time of arrival of the same response signal 331 measured at the activator-reader apparatus 100).

This authentication could occur at the apparatus 200 if the signature {t3} is communicated by the activator-reader apparatus 100 to the apparatus 200. The signature {t3) is the ordered set of time of arrival measurements made at the activator-reader apparatus 100 for the ordered set of response signals 331 produced by the set of passive radios 300 in response to an ordered set of passive radio activation signals 133.

This authentication could occur at the activator-reader apparatus 100 if the signature {t2} is communicated by the apparatus 200 to the activator-reader apparatus 100. The signature {t2) is the ordered set of time of arrival measurements made at the apparatus 200 for the same ordered set of response signals 331 produced by the same set of passive radios 300 in response to the same ordered set of passive radio activation signals 133.

FIG. 4C illustrates an example where the signature 21 ({ΔT}ᵤₛₑ) is compared 170 to the reference signature 22 ({ΔT}_{ref}), at the apparatus 200, to authenticate 20 physical integrity. The signature 21 ({ΔT}ᵤₛₑ) requires {t2}(the time of arrival of the response signal 331 measured at the apparatus 200) and {t3}(the time of arrival of the same response signal 331 measured at the activator-reader apparatus 100). The set {t3}(the time of arrival of the same response signal 331 measured at the activator-reader apparatus 100) is transferred from the activator-reader apparatus 100 to the apparatus 200 in order to determine the signature 21 ({ΔT}ᵤₛₑ). The activator-reader apparatus 100 transmits a transfer signal 175 comprising the set {t3}. The comparison 170 requires the signature 21 ({ΔT}ᵤₛₑ) and the reference signature 22 ({ΔT}_{ref}). The reference signature 22 ({ΔT}_{ref}) can be obtained in the same way as the signature 21 ({ΔT}ᵤₛₑ) is obtained but at an earlier time. The result of the comparison, the authentication determination, is transferred from the apparatus 200 to the activator-reader apparatus 100. The activator-reader apparatus 100 transmits an activation request signal 171 and the apparatus 200 responds with an authentication response signal 172 based on the authentication determination.

FIG. 4D illustrates an example where the signature 21 ({ΔT}ᵤₛₑ) is compared 170 to the reference signature 22 ({ΔT}_{ref}), at the activator-reader apparatus 100, to authenticate physical integrity.

The signature 21 ({ΔT}ᵤₛₑ) requires {t2}(the time of arrival of the response signal 331 measured at the apparatus 200) and {t3}(the time of arrival of the same response signal 331 measured at the activator-reader apparatus 100). The set {t2}(the time of arrival of the response signal 331 measured at the apparatus 200) is transferred from the apparatus 200 to activator-reader apparatus 100) in order to determine the signature 21 ({ΔT}ᵤₛₑ).

The activator-reader apparatus 100 transmits a transfer request signal 177 requesting transfer of the set {t2} and the apparatus transmits in reply a transfer response signal 178 comprising the set {t2}. The comparison 170 requires the signature 21 ({ΔT}ᵤₛₑ) and the reference signature 22 ({ΔT}_{ref}). The reference signature 22 ({ΔT}_{ref}) can be obtained in the same way as the signature 21 ({ΔT}ᵤₛₑ) is obtained but at an earlier time.

In some examples, activator-reader apparatus 100 (or apparatus 200) determines whether the comparison 170 is based on a time-of-arrival signature based on {t2}(the time of arrival of the response signal 331 measured at the apparatus 200) or a time-of-flight signature 21 based on {ΔT}(the time of flight of the response signal 331 from passive radio 200 to apparatus 200) and/or whether the comparison 170 is performed at the apparatus 200 or the activator-reader apparatus 100. For example, in some examples, the comparison 170 uses a time-of-flight signature 21 based on {ΔT}(the time of flight of the response signal 331 from passive radio 200 to apparatus 200) if it is detected that the activator-reader apparatus 100 has moved and/or if it is detected that the passive radios 200 have collectively moved. This can, for example, be determined if the apparatus 200 is attached to the same object as the passive radios 200 and it is detected that the apparatus 200 has moved.

It should also be appreciated that different signatures can be used based on measured positional characteristics including not only time of arrival but alternatively or additionally angle of arrival and/or signal strength etc.

The apparatus 200 is configured to measure positional characteristic(s) 10 of each response 331 from a respective passive radio 300 that is dependent upon at least a relative position of the respective passive radio and the apparatus 200. These define a signature 21 (e.g. a ToA signature {t2}) for the apparatus 200.

In examples such as those illustrated in FIGS. 4C and 4D, the activator-reader apparatus 100 is configured to measure positional characteristic(s) 10 of each response 331 from a respective passive radio 300 that is dependent upon at least a relative position of the respective passive radio and the apparatus 200. These define a signature (e.g. ToA signature {t3}) for the activator-reader apparatus 100 which is used to adjust the signature 21 (e.g. ToA signature {t2}) of the apparatus 200 to obtain an adjusted signature (e.g. time-of-flight signature {ΔT}) for the apparatus 200.

In the example of FIG. 4C, the activator-reader apparatus 100 receives responses 331 from the plurality of passive radios 300 that has been selectively activated 133 and adjusts the signature e.g. {t2} for the plurality of passive radios based on the received responses from the plurality of passive radios that have been selectively activated e.g. based on {t3}.

The signature is based on responses 331 from the plurality of passive radios 300 that has been selectively activated 133 received at the apparatus 200.

In the example of FIG. 4D, the apparatus 100 receives responses 33 1 from the plurality of passive radios 300 that has been selectively activated 133 and adjusts a signature e.g. {t2} for the plurality of passive radios based on the received responses from the plurality of passive radios that have been selectively activated e.g. based on {t3}.

It will therefore be appreciated from the examples of FIG. 4A to 4D that a signature 21 is compared 170 to a reference signature 22 to authenticate 20 physical integrity

The comparison determines whether the signature 21 for the plurality of passive radios 300 matches a reference signature 22 for the plurality of passive radios 300.

FIG. 5 illustrates an example based on the example of FIG. 1 and FIG. 4C and similar references are used to identify similar features. In this example, all the passive radios 300 are attached to an object 350.

The apparatus 200 is charged via a radio signal 101 and activated via a first activation signal 131. It sends response 231 indicating a plurality of activation identifiers for a respective plurality of passive radios 300. The signal 137 causes the apparatus 200 to prepare 250 for receiving passive radio responses. The activator-reader 100 activates passive radios 300 of an object 350 via passive radio activation signals 133. The activation is selective because each passive radio activation signal 133 uses one of the plurality of activation identifiers 212. The passive radios 300 transmit responses 331. Positional characteristics 10 of the responses 331 are measured to obtain a signature 21 at the apparatus 200 (and also at the activator-reader 100). The activator-reader 100 activates the apparatus 200 via second activation signal 173 (signature request signal) and the apparatus 200 transmits a signature response signal 174 comprising information dependent upon the obtained signature 21. The activator-reader 100 determines if the physical object 350 retains physical integrity based on signature 21 of positional characteristics 10 of the passive radio responses 331 from the passive radios 300 of the object 350.

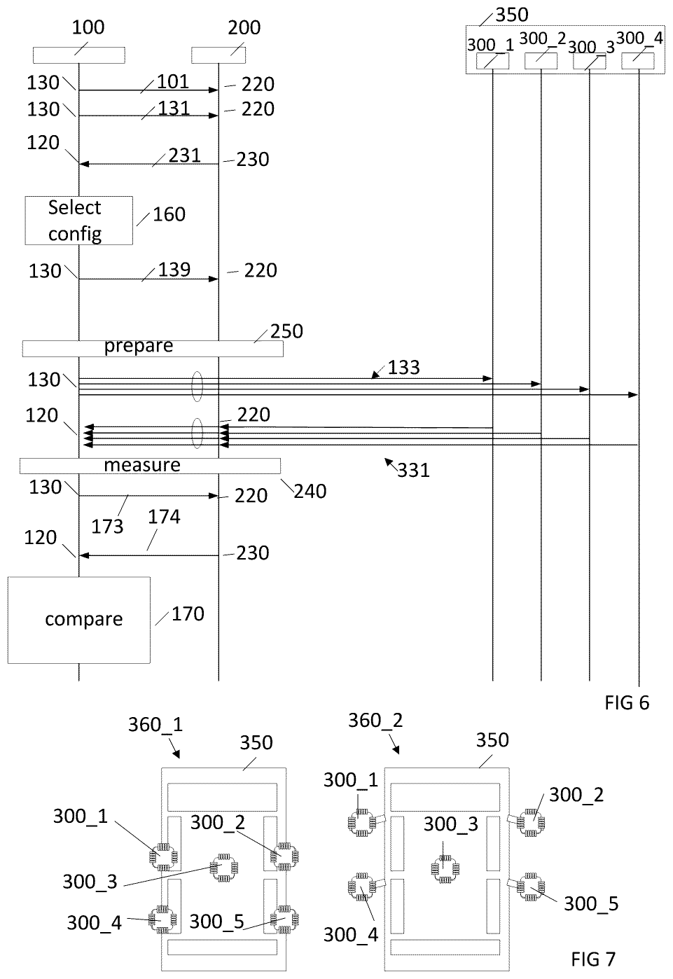

FIG. 6 and FIG. 7 illustrate an extension of the concept to scenarios where the there are different normative (standard) physical configurations 360 of an object to which the passive radios 300 are attached. Each one of the different normative physical configurations 360 of the object (in an undamaged state) is associated with a respective reference signature . . . Thus each different one of the multiple different physical configurations 360_i of the object to which the passive radios 300 are attached is associated with a respective signature 21_i and a respective reference signature 22_i.

The signatures 21 and reference signatures 22 are not illustrated in FIG. 6 or 7 but have been previously illustrated in other figures.

An object can therefore have multiple different configurations 300_1, 300_2. Each of the different configuration 300_1, 300_2 has an expected arrangement of passive radios 300 and each of those expected single arrangements of passive radios 300 has an associated expected reference signature 22_i appropriate for that configuration 300_i.

If the object is in one of multiple different configurations 300_j it has a current arrangement of passive radios 300 and the current arrangement of passive radios 300 has an associated respective current signature 21_j.

If the current signature 21_j for a current configuration 300_j matches a reference signature 22J for the same current configuration 300_j then it can be inferred that the object is undamaged.

If the current signature 21_j for the current configuration 300_j does not match a reference signature 22J for the same current configuration 300_j then it can be inferred that the object is damaged.

The apparatus that generates, stores, or uses a reference signature, in this example stores a reference signature 22_i for each expected configuration 360_i of the plurality of passive radios 300. As previously described, a reference signature 22 for a plurality of passive radios 300 is dependent upon reference positional characteristics 10 for the plurality of passive radios 300.

When a reference signature 22_i is to be used it can be selected from a stored set of reference signatures or a transferred set of reference signatures based on the current configuration 360_i. Alternatively a reference signature 22_i selected from a stored set of reference signatures can be transferred for use.

In the example illustrated in FIG. 4A or 4C, the reference signature 22 used in the comparison 170 is selected at the apparatus 200 from a set of reference signatures.

In the example illustrated in FIG. 4B or 4D, the reference signature 22 used in the comparison 170 is selected at the activator-reader apparatus 100 from a set of reference signatures transferred, for example previously transferred, from the apparatus 100 or, the reference signature 22 used in the comparison 170 is selected at the apparatus 200 from a set of reference signatures and transferred to the activator-reader apparatus 100.

In at least some examples, the apparatus that performs the selection of the reference signature 22_i from the set of reference signatures 22 receives a signal 139 indicating one of a plurality of configurations 260.

In the example illustrated in FIG. 6, the reference signature 22 used in the comparison 170 is selected at the activator-reader apparatus 100.

The signal 231 that indicates the plurality of activation identifiers 212 including an activation identifier 212 for each of a plurality of passive radios 300 additionally comprises information for each registered physical structure configurations 360. This information can include the set of reference signatures 22.

The activator-reader apparatus 100 selects 160 a physical structural configuration 250_i.

The activator-reader apparatus 100 transmits the signal 139 indicating, for each of the plurality of activation identifiers 212, a configuration 360 for receiving responses 331 from a respective passive radio 300 that has been activated 133 using the respective activation identifier 212. Optionally the configuration under test can also be identified.

The method then proceeds as previously described.

The activator-reader 100 activates passive radios 300 of an object 350 via passive radio activation signals 133. The activation is selective because each passive radio activation signal 133 uses one of the plurality of activation identifiers 212. The passive radios 300 transmit responses 331. Positional characteristics 10 of the responses 331 are measured to obtain a signature 21 at the apparatus 200 (and also at the activator-reader 100).

The activator-reader 100 activates the apparatus 200 via second activation signal 173 (signature request signal) and the apparatus 200 transmits a signature response signal 174 comprising information dependent upon the obtained signature 21.

The comparison 170 determines if the physical object 350 retains physical integrity (for the selected structural configuration under test). The comparison compares the current signature provided by the apparatus 200 via the signal 174 with the appropriate reference signature for the configuration 360_i.

FIG. 7 illustrates an example of an object 350 (vehicle) that has a first configuration 360_1 (doors closed) and a second configuration 360_2 (doors open). There is a different passive radio 300 attached to each door. The system is able to interrogate the passive radios 300 to detect damage (loss of integrity) in both the first configuration 360_1 and the second configuration 360_2 FIG. 8 illustrates an example of setting up the system so that it has a reference signature 22. The process for generating the in-use signature 21 can be performed at an earlier time to obtain the reference signature 22.

The activator-reader apparatus 100 transmits a first set-up activation signal 161 which is received by the apparatus 200. The apparatus 200 transmits, in reply to the first set-up activation signal 161, a signal 231 that indicates the plurality of activation identifiers. The signal 231 is received by the activator-reader apparatus 100.

The activator-reader apparatus 100 sends (set-up) passive radio activation signals 133 to the passive radios 300 using the respective activation identifiers 212. The passive radios 200 reply with (set-up) response signals 331.

The apparatus 200 measures 242 at least a positional characteristic 10 of each set-up response 331 from a respective passive radio 300 that is dependent upon at least a relative position of the respective passive radio 300 and the apparatus 200. This defines a reference signature (e.g. ToA reference signature {t2}) for the plurality of passive radios at the apparatus 200.

Optionally, the apparatus 100 measures 262 at least a positional characteristic 10 of each set-up response 331 from a respective passive radio 300 that is dependent upon at least a relative position of the respective passive radio 300 and the activator-reader apparatus 100. This defines a reference signature (e.g. ToA reference signature{t3}) for the plurality of passive radios at the activator-reader apparatus 100.

In some examples, the reference signature for the activator-reader apparatus 100 (e.g. ToA reference signature {t3}) and the reference signature for the apparatus 200 (e.g. ToA reference signature {t2}) are combined 160 to create an adapted signature (e.g. time-of-flight signature {ΔT} for the apparatus 200}.

In the example illustrated, the activator-reader apparatus 100 transmits a ToA second set-up activation signal 163 to the apparatus 200 which is received by the apparatus 200. The apparatus 200 transmits, in reply to the second set-up activation signal 163, a set-up signal 261 that indicates a reference signature 22 (e.g. ToA reference signature {t2}) for the plurality of passive radios dependent upon the plurality of positional characteristics.

In this example, the a reference signature 22 is stored 162 for future use.

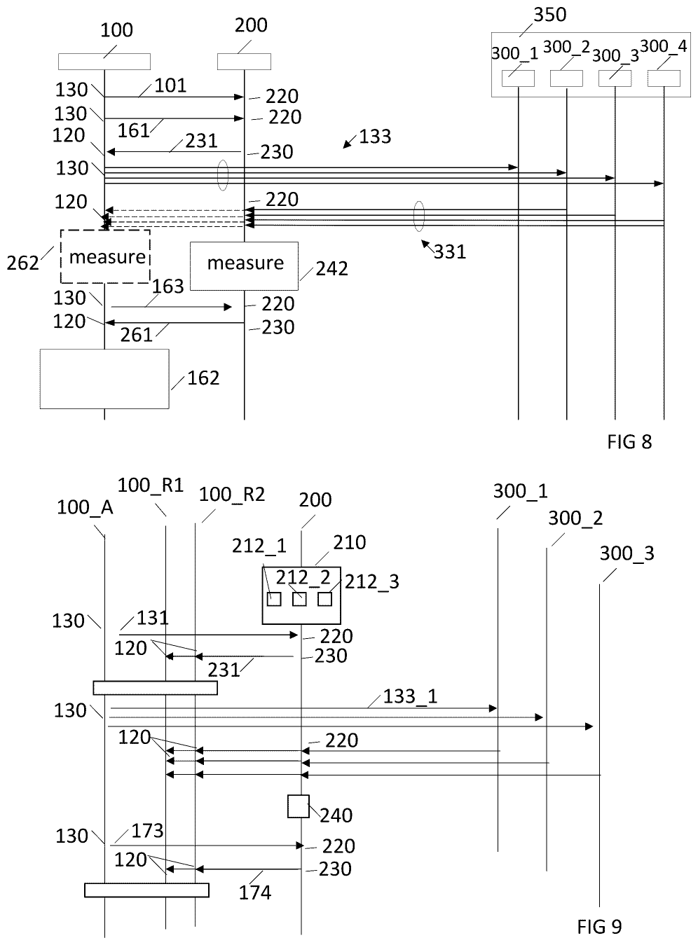

FIG. 9 illustrates an example where an activator-reader apparatus 100 is spilt into an activator apparatus 100_A and one or more reader apparatus 100_R1, 100_R2. The apparatus 200 is optionally charged via a radio signal (not illustrated) and activated via a first activation signal 131. The apparatus 200 sends response 231 indicating a plurality of activation identifiers 212 for a respective plurality of passive radios 300. The response 231 is received at a reader 100_R1 (and/or 100_R2). The activator 100_A and a reader 100_R1 (and/or 100_R2) communicate to inform the activator 100 of the plurality of activation identifiers 212 The activator 100_A activates passive radios 300 of an object 350 via transmission of passive radio activation signals 133. The activation is selective because each passive radio activation signal 133 uses one of the plurality of activation identifiers 212. The passive radios 300 transmit responses 331. Positional characteristics of the responses 331 are measured at the apparatus 200 to obtain signature 21 at the apparatus 200. Positional characteristics 10 of the responses 331 are measured at the reader 100_R1 (and/or the reader 100_R2) to obtain a signature at the reader. The activator 100 activates the apparatus 200 via a second activation signal 173 (signature request signal) and the apparatus 200 transmits a signature response signal 174 comprising information dependent upon the obtained signature 21. The activator 100_A or a reader reader 100_R1, 100_R2 determines if the physical object 350 retains physical integrity based at least on signature 21 of positional characteristics 10 of the passive radio responses 331 from the passive radios 300 of the object 350.

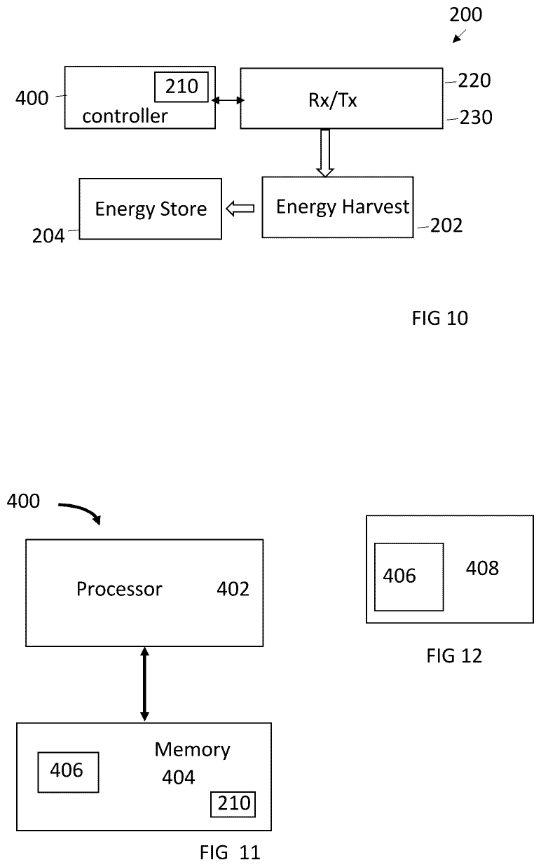

FIG. 10 illustrates an example where the apparatus 200 is configured for energy harvesting.

The apparatus 100 comprises an energy store 204 for powering the apparatus 100. The apparatus 100 also comprises energy harvesting means 202 for charging the energy store via energy harvesting from an external energy source 101.

In at least some example, the external energy source 101 is received radio signals 101 within a defined bandwidth. The received radio signals 101 can be transmitted by the activator-reader apparatus 100.

The apparatus 100 is configured to use the energy store 204 for powering a controller 400 used for measuring and storing, a transmitter 230 (Tx) for transmitting, a receiver 220 (Rx) for receiving.

FIG. 11 illustrates an example of a controller 400 suitable for use in an apparatus 100, 200. Implementation of a controller 400 may be as controller circuitry. The controller 400 may be implemented in hardware alone, have certain aspects in software including firmware alone or can be a combination of hardware and software (including firmware).

As illustrated in FIG. 11 the controller 400 may be implemented using instructions that enable hardware functionality, for example, by using executable instructions of a computer program 406 in a general-purpose or special-purpose processor 402 that may be stored on a computer readable storage medium (disk, memory etc) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus 100, 200 when loaded into the processor 402. The computer program instructions, of the computer program 406, provide the logic and routines that enables the apparatus to perform the methods illustrated in the accompanying FIGS. The processor 402 by reading the memory 404 is able to load and execute the computer program 406.

In some examples, the apparatus 200 comprises: at least one processor 402; and at least one memory 404 including computer program code, the at least one memory storing instructions that, when executed by the at least one processor 402, cause the apparatus at least to: store a plurality of activation identifiers 212, wherein each activation identifier 212 of the plurality of activation identifiers is associated with a respective passive radio 300 of a plurality of passive radios; transmit, in reply to a received first activation signal, a signal that indicates the plurality of activation identifiers; measure at least a positional characteristic of responses from passive radios, wherein the positional characteristic is dependent upon at least a relative position of the respective passive radios and the apparatus.

In some examples, the apparatus 100 comprises: at least one processor 402; and at least one memory 404 including computer program code, the at least one memory storing instructions that, when executed by the at least one processor 402, cause the apparatus at least to: transmit to another apparatus 200 a first activation signal; receive from the other apparatus, in reply to the first activation signal, a signal that indicates a plurality of activation identifiers including an activation identifier for each of a plurality of passive radios and use each of the plurality of activation identifiers to activate the respective passive radio of the plurality of passive radios; send to the apparatus a second activation signal; and receive from the apparatus in reply to the second activation signal, a signal that indicates a signature for the plurality of passive radios dependent upon relative positions between the respective passive radio, when activated, and the apparatus and authenticate the signature for the plurality of passive radios.

As illustrated in FIG. 12, the computer program 406 may arrive at the apparatus 100, 200 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus 100, 200 may propagate or transmit the computer program 406 as a computer data signal.

In some examples, there is provided computer program instructions for causing an apparatus 200 to perform at least the following or for performing at least the following: store a plurality of activation identifiers, wherein each activation identifier of the plurality of activation identifiers is associated with a respective passive radios of a plurality of passive radios; transmit, in reply to a received first activation signal, a signal that indicates the plurality of activation identifiers; measure at least a positional characteristic of responses from passive radios, wherein the positional characteristic is dependent upon at least a relative position of the respective passive radios and the apparatus.

In some examples, there is provided computer program instructions for causing an apparatus 200 to perform at least the following or for performing at least the following: transmit to another apparatus a first activation signal; receive from the other apparatus, in reply to the first activation signal, a signal that indicates a plurality of activation identifiers including an activation identifier for each of a plurality of passive radios and use each of the plurality of activation identifiers to activate the respective passive radio of the plurality of passive radios; send to the apparatus a second activation signal; and receive from the apparatus in reply to the second activation signal, a signal that indicates a signature for the plurality of passive radios dependent upon relative positions between the respective passive radio, when activated, and the apparatus and authenticate the signature for the plurality of passive radios.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry.

References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and (ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying FIGS. may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The above-described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning.

That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples.

Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. An apparatus comprising
at least one processor, and
at least one memory storing computer program codes that, when executed by the at least one processor, cause the apparatus at least to:
store a plurality of activation identifiers, wherein each activation identifier of the plurality of activation identifiers is associated with a respective passive radio of a plurality of passive radios;
receive a first activation signal;
transmit, in reply to the first activation signal, a response signal that indicates at least one of the plurality of activation identifiers;
receive a response from the respective at least one passive radio that has been activated using the respective at least one activation identifier;
measure at least a positional characteristic of the response from the respective at least one passive radio that is dependent upon at least a relative position between the respective at least one passive radio and the apparatus.

2. The apparatus as claimed in claim 1, wherein the at least one memory and the computer program codes, when executed by the at least one processor further cause the apparatus to:
authenticate a signature for some or all of the plurality of passive radios dependent upon the plurality of positional characteristics, wherein the signature is a signature for all of the passive radios, or the signature is a signature for a sub-set of the passive radios.

3. The apparatus as claimed in claim 2, wherein the authentication comprises a comparison based on the signature and a reference signature.

4. The apparatus as claimed in claim 3, wherein the signature and the reference signature are time-of-arrival signatures, adapted to time-of-flight signatures, before comparison.

5. The apparatus as claimed in claim 1, wherein the at least one memory and the computer program codes, when executed by the at least one processor further cause the apparatus to:
receive a second activation signal and for transmitting in reply to the second activation signal, a signature response signal that indicates a signature for some or all of the plurality of passive radios dependent upon the plurality of positional characteristics, wherein the signature is a signature for all of the passive radios, or the signature is a signature for a sub-set of the passive radios.

6. The apparatus as claimed in claim 1, wherein the at least one memory and the computer program codes, when executed by the at least one processor further cause the apparatus to:
receive a configuration signal indicating, for each of the plurality of activation identifiers, a configuration for receiving the response from a respective at least one passive radio that has been activated using the respective activation identifier, or
receive a configuration signal indicating, for each of the plurality of activation identifiers, a configuration for receiving the response from a respective at least one passive radio that has been activated using the respective activation identifier.

7. The apparatus as claimed in claim 1, wherein the at least one memory and the computer program codes, when executed by the at least one processor further cause the apparatus to:
receive a first set-up activation signal;
transmit, in reply to the first set-up activation signal, a first set-up response signal that indicates some or all of the plurality of activation identifiers;
receive, for each of the some or all of the plurality of activation identifiers, a set-up response from a respective passive radio that has been activated using the respective activation identifier;
measure at least a positional characteristic of each set-up response from a respective passive radio that is dependent upon at least a relative position between the respective passive radio and the apparatus;
generate a reference signature for the some or all of the plurality of passive radios dependent upon the plurality of positional characteristics, wherein the authentication of the signature uses the reference signature, wherein the reference signature is a reference signature for all of the passive radios or the reference signature is a reference signature for a sub-set of the passive radios or the reference signature is a reference signature for a sub-set, being associated with an object, of the passive radios.

8. The apparatus as claimed in claim 1, wherein the at least one memory and the computer program codes, when executed by the at least one processor further cause the apparatus to
store reference signatures, wherein each reference signature is dependent upon reference positional characteristics for all of the plurality of passive radios in different configurations, or wherein each reference signature is dependent upon reference positional characteristics for a sub-set of the plurality of passive radios in different configurations,
receive a configuration signal indicating one of a plurality of configurations, and transmit a reference signature indication signal that indicates a reference signature for the indicated one of the plurality of configurations.

9. An apparatus comprising:
at least one processor, and
at least one memory storing computer program codes that, when executed by the at least one processor, cause the apparatus at least to: transmit to another apparatus a first activation signal; and
receive from the another apparatus, in reply to the first activation signal, a response signal that indicates one or more activation identifiers wherein each activation identifier is associated with a respective passive radio of a plurality of passive radios.

10. The apparatus as claimed in claim 9, wherein the at least one memory and the computer program codes, when executed by the at least one processor further cause the apparatus to:
use at least one of the plurality of activation identifiers to activate the respective passive radio of the plurality of passive radios.

11. The apparatus as claimed in claim 9, wherein the at least one memory and the computer program codes, when executed by the at least one processor further cause the apparatus to:
transmit a second activation signal to the another apparatus, and receive, in reply to the second activation signal, a second response signal providing a result of authentication of a signature for some or all of the plurality of passive radios; and/or
transmit a third activation signal to the another apparatus, and receive in reply a third response signal enabling at the apparatus authentication of a signature for some or all of the plurality of passive radios.

12. The apparatus as claimed in claim 9, wherein the at least one memory and the computer program codes, when executed by the at least one processor further cause the apparatus to:
send to the another apparatus a second activation signal;
receive from the another apparatus in reply to the second activation signal, a signature response signal that indicates a signature for some or all of the plurality of passive radios dependent upon relative positions between the respective passive radio and the another apparatus; and
authenticate the signature for some or all of the plurality of passive radios.

13. The apparatus as claimed in claim 12, wherein the at least one memory and the computer program codes, when executed by the at least one processor further cause the apparatus to:
determine whether the signature for some or all of the plurality of passive radios matches a reference signature for some or all of the plurality of passive radios.

14. The apparatus as claimed in claim 12, wherein the at least one memory and the computer program codes, when executed by the at least one processor further cause the apparatus to:
receive responses from some or all of the plurality of passive radios that have been activated;
adjust the signature for some or all of the plurality of passive radios based on the received responses from the some or all of the plurality of passive radios that have been activated.

15. The apparatus as claimed in claim 12,
wherein the at least one memory and the computer program codes, when executed by the at least one processor further cause the apparatus to:
transmit a configuration signal indicating one of a plurality of configurations, and receive a reference signature indication signal that indicates a reference signature for the configuration.

16. A method for an apparatus comprising:
storing a plurality of activation identifiers, wherein each activation identifier of the plurality of activation identifiers is associated with a respective passive radio of a plurality of passive radios;
receiving a first activation signal;
transmitting, in reply to the first activation signal, a response signal that indicates at least one of the plurality of activation identifiers;
receiving a response from the respective at least one passive radio that has been activated using the respective at least one activation identifier;
measuring at least a positional characteristic of the response from the respective at least one passive radio that is dependent upon at least a relative position between the respective at least one passive radio and the apparatus.

17. The method as claimed in claim 16, further comprising authenticating a signature for some or all of the plurality of passive radios dependent upon the plurality of positional characteristics, wherein the signature is a signature for all of the passive radios or the signature is a signature for a sub-set of the passive radios.

18. The method as claimed in claim 17, wherein the authentication comprises a comparison based on the signature and a reference signature.

19. The method as claimed in claim 18, wherein the signature and the reference signature are time-of-arrival signatures, adapted to time-of-flight signatures, before comparison.

20. The method as claimed in claim 16, further comprising:
receiving a second activation signal and transmitting in reply to the second activation signal, a signature response signal that indicates a signature for some or all of the plurality of passive radios dependent upon the plurality of positional characteristics, wherein the signature is a signature for all of the passive radios or the signature is a signature for a sub-set of the passive radios.
